(19) United States
(12) Patent Application Publication
(10) Pub. No.: US 2018/0085996 A1
(43) Pub. Date: Mar. 29, 2018

(54) METHOD FOR GENERATING 3D OBJECTS

(71) Applicant: HEIDELBERGER DRUCKMASCHINEN AG, HEIDELBERG (DE)

(72) Inventors: BERNARD BEIER, LADENBURG (DE); GUIDO HIERL, SANDHAUSEN (DE); MARTIN SCHMITT-LEWEN, HEIDELBERG (DE); THOMAS STEIGLEDER, MAUER (DE)

(21) Appl. No.: 15/716,991

(22) Filed: Sep. 27, 2017

(30) Foreign Application Priority Data
Sep. 29, 2016 (DE) 102016218837.2

(51) Int. Cl. B29C 64/147; G03G 15/22; B33Y 10/00

(52) U.S. Cl. CPC B29C 64/147; B41J 2/01; B33Y 10/00; G03G 15/224

(57) ABSTRACT

A method for generating 3D objects includes providing a web of material, printing an image by inkjet printing in which the image corresponds to a section in a plane of the 3D object to be generated, applying a powder to the portion of the web of material that is provided with the image, cross-cutting the printed web of material into sheets, stacking the sheets on a stack of sheets, repeating the printing, powder application, cross-cutting and stacking steps, pressing the stack of sheets and exposing the object. 3D objects can be manufactured quickly, inexpensively and precisely with the method.

### CROSS-REFERENCE TO RELATED APPLICATION

This application claims the benefit, under 35 U.S.C. § 119, of German Patent Application DE 10 2016 218 837.2, filed Sep. 29, 2016; the prior application is herewith incorporated by reference in its entirety.

### BACKGROUND OF THE INVENTION

### Field of the Invention

The invention relates to a method for generating 3D objects.

### Description of the Related Art

Additive manufacturing methods, which are also referred to as 3D printing, are known for producing three-dimensional objects. Those methods involve building up the objects from plastics, synthetic resins, ceramics and metals, as well as mixtures of those materials, on the basis of CAD data. The materials are applied in many layers one on top of the other by fusing, sintering or other processes, with the printed images of the individual layers being derived from the CAD data.

U.S. Publication US 2016/0082658 A1 discloses an additive manufacturing method which builds up an object on the basis of fiber-containing sheets. A thermoplastic powder is applied to the sheets, excess powder is removed so as to leave a powder image, the powdered sheets are cut to size, the cut-to-size blanks are stacked and aligned with one another, pressed as a package and baked. The object to be manufactured is thereby created from the hardened thermoplastic powder. The material surrounding the object can be removed, for example, by sandblasting.

A disadvantage of that method is the high proportion of manual work required, so that it is only possible to economically produce relatively small objects in small numbers. It is also problematic that the method steps to be performed during the aligning and stacking may cause an offset between the powder images of the individual blanks, which produces inaccuracies in the object.

### SUMMARY OF THE INVENTION

It is accordingly an object of the invention to provide a method for generating 3D objects, which overcomes the hereinafore-mentioned disadvantages of the heretofore-known methods of this general type and with which the objects can be manufactured quickly, inexpensively and precisely.

With the foregoing and other objects in view there is provided, in accordance with the invention, a method for generating 3D objects, comprising the following steps:
In a first step, a web of material is provided, the web of material acting as a carrier material and being constructed, for example, as a woven fabric with a regular fiber structure or a nonwoven fabric with an irregular fiber structure, in particular including wood-containing, carbon-fiber-containing, mineral or plastic-based fibers.
In the next step, an image is printed onto the web of material with a fluid by inkjet printing, the image corresponding to a section in a plane of the 3D object to be generated. The printing data of the image to be printed, which is obtained from the cross section through the object in a specific sectional plane, can be obtained from the underlying CAD data of the 3D object, which for this purpose is broken down into a multiplicity of layers. The data preparation is performed by using methods known to a person skilled in the art with the aid of software and computers. After the printing of an image, a powder, for example a resin-containing powder, is uniformly applied to the portion of the web of material that is provided with the image, the powder adhering at the locations with wet fluid. The locations that are provided with powder will later form the structure of the 3D object. Subsequently, the printed web of material is cross-cut into individual sheets. The sheets are then stacked in precise register on a stack of sheets. The aforementioned steps of printing, powdering and cross-cutting are repeated as often as required until all of the layers, that is to say all of the sectional planes, of the object have been stacked one on top of the other. The stack of sheets is then pressed in-register, possibly by using the effect of heat. The powder material is thereby cured.

Then, the 3D object can be exposed by applying mechanical or chemical action to the pressed stack of sheets, for example by sandblasting, so that all that remains from the powder composite material is the cured 3D object.

The described method offers very good substrate handling, that is to say the transporting of first the web of material, then the sheets and finally the stack can be accomplished by using transporting devices for the web, sheet and stack transport that have been tried and tested over many years. Due to an optimization of the transporting technology, the method for generating 3D objects is capable of achieving a very high level of performance.

In an advantageous variant of an embodiment of the method, before the printing on of the image, the side edges of the web of material are strengthened. In other words: the web of material is strengthened at the edges. This serves for stabilizing the web of material and prevents distortion of the web, and is achieved, for example, by folding over, hemming or impregnating the edge of the web, for example with a hot melt adhesive. The strengthening of the material may also be applied together with the image. This strengthening of the material possibly has to be removed before the forming of the stack in the course of the process, for example immediately before the method step of cross-cutting by using two longitudinal cutters positioned at the edges.

It is regarded as particularly advantageous if, when printing on the image of a sectional plane, sections of a number of objects are printed in nested positioning, for example next to one another or one inside the other. This serves on one hand for better utilization of the surface area of the web of material, in a manner analogous to the printing of multiple repeats of folded boxes or jobbing work, and on the other hand for loading the available surface area more uniformly, and in this manner the stability of webs of material, printed sheets and stacks of sheets can also be increased. The sheets can be stacked better with a uniformly distributed application of powder over the surface area of the sheets. The process step of exposing the 3D object can also be performed in a shorter time, since less edge material has to be removed. If it is not necessary when carrying out the method for a number of 3D objects to be generated in one pass, it may be required that supporting structures necessary for the required stability during the further processing steps are printed on and powdered.

It is proposed to use an inkjet printing unit with at least one inkjet printhead for the method step of printing on an image. The data preparation, activation and actuation of an inkjet print head are particularly suitable for the method described.

A powder unit, which may also be referred to as a powder inking unit and has in particular an electrostatic powder roller in order to apply the powder material without any dust, may be used for applying the powder. It appears advantageous in this respect if both the inkjet printing unit and the powder unit are disposed on the same side of the web of material, in particular above the web of material. If the inkjet fluid impregnates the web of material sufficiently, the inkjet printing unit and the powder unit may alternatively also be disposed on different sides of the web of material. It is also advantageous if the web of material is guided substantially horizontally in the region of the inkjet printing unit and the powder unit, so that inkjet fluid and powder can be applied particularly precisely.

In an alternative variant embodiment, an inkjet printing unit for applying an image by inkjet printing could be respectively disposed on both sides of the web of material and the web of material could be guided through between the two inkjet printing units vertically.

In a particularly advantageous and therefore preferred variant embodiment of the method, excess powder is removed directly after the application of the powder by being blasted away or sucked off.

In a particularly advantageous and therefore preferred variant of an embodiment of the method, the adhering powder is prefixed on the web of material, for example by the effect of heat, after the application of the powder and possibly after the removal of excess powder. In this case, the powder is fixed to the extent that it does not become detached from the web of material during the further transport of the web of material, or later during the further transport of the sheets and the stacking of the sheets.

It is also conceivable that, before the stacking of the sheets, further sheets with various functionality are fed in between the printed and powdered sheets. It is possible for a separating sheet to be introduced, whereby a stack that is formed of a number of components lying one on top of the other can be easily separated after pressing. It is also possible to introduce electrically functional sheets, for example flexible printed circuit boards loaded with electronic components. It is also possible to introduce sheets with other mechanical functionality, for example metallic-elastic resilient sheets or sheets with metallic-ductile functions. Thick sheets or blocks of sheets including multiple sheets that have a greater stiffness and serve for stabilization in the vertical direction may be introduced. Sheets with other thermal properties, for example metallic-thermal functions, may also be introduced into the stack. Sheets with magnetic functions or with graphic functions, for example colored or monochrome sheets, may also be fed in as an outer or inner cover sheet of the 3D object to be manufactured.

As an alternative to sheets, individual fibers could also be specifically “fired in,” i.e. introduced into the stack, as functional fibers. These may, for example, be optical fibers, carbon fibers or resistance wire (heating wire).

In addition to the inkjet head already described above, one or more further inkjet heads that print ink and/or functional fluids, for example electrically conductive materials, onto a sheet, may be used. This allows a coloring of the object to be performed or, for example, a printed sensor element to be integrated into the object.

With the objects of the invention in view, there is concomitantly provided an alternative variant of an embodiment of the method for generating 3D objects, in which an electrophotographic printing unit, which allows an image to be printed onto the web of material on one or both sides, with the image corresponding to a section in a plane of the 3D object to be generated, is used instead of the inkjet printing unit and the powder unit. In the case of printing on both sides, two-component material may preferably be used for the printing, with the two components curing when they come into contact with one another. The further method steps of providing a web of material, cross-cutting, stacking, pressing and exposing are performed in the same way as in the case of the method already described above.

The combination of an inkjet printing unit from above and an electro photographic printing unit from below is also conceivable.

Other features which are considered as characteristic for the invention are set forth in the appended claims.

Although the invention is illustrated and described herein as embodied in a method for generating 3D objects, it is nevertheless not intended to be limited to the details shown, since various modifications and structural changes may be made therein without departing from the spirit of the invention and within the scope and range of equivalents of the claims. The described invention and the described advantageous developments of the invention also represent advantageous developments of the invention in combination with one another, if this is technically appropriate.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of a system for creating 3D objects;

FIG. 2 is a side-elevational view of an alternative variant of an embodiment of a system for creating 3D objects;

FIG. 3 is a side-elevational view of the system of FIG. 1 with an additional functionality for feeding in sheets; and

FIG. 4 is a fragmentary, cross-sectional view of a printed and powdered image of various 3D objects nested in one another.

### DETAILED DESCRIPTION OF THE INVENTION

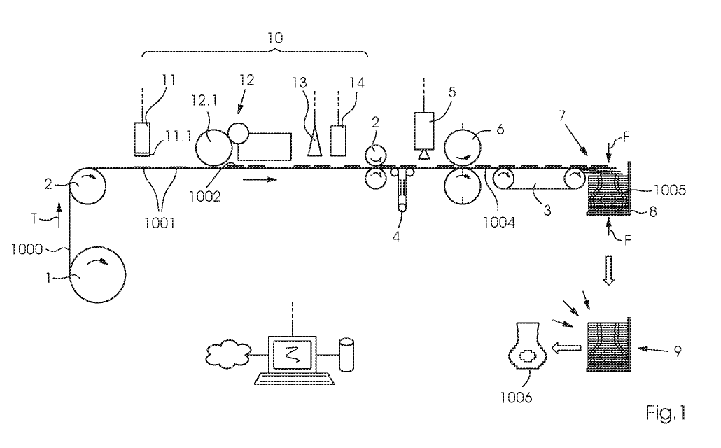

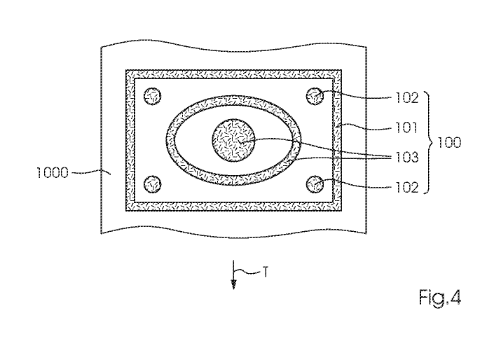

Referring now in detail to the figures of the drawings, which are not true-to-scale and in which corresponding elements and components are provided with the same reference numerals, and first, particularly, to FIG. 1 thereof, there is seen a system for creating 3D objects 1006. A web of material 1000 is provided by an unwinder 1 and is transported in a transporting direction T by web transporting elements 2, to be specific deflecting, guiding and driving transporting rollers and compensating rollers 4. The web of material 1000 is guided along under an inkjet imaging system 10. The inkjet imaging system 10 includes an inkjet printing unit 11, a powder unit 12, a suction/blowing device 13 and a device 14 for thermal prefixing. The web of material 1000 is transported through under the inkjet printing unit 11 and the powder unit 12, with inkjet fluid 1001 being printed onto the web of material 1000 by the inkjet printing unit 11 having a printhead 11.1. In the following powder unit 12, powder material 1002 is applied to the web of material 1000, with the powder material 1002 adhering to the web of material 1000 in the region of the inkjet fluid 1001. In order to avoid the powder producing dust when it is transferred onto the web of material 1000, the powder unit may be equipped with electrostatic assistance, for example an electrostatic powder roller 12.1. Optionally, the suction/blowing device 13 and/or the device 14 for the thermal prefixing of the powder material 1002 may be disposed downstream of the powder unit 12. The suction/blowing device 13 allows excess powder material 1002 to be removed. The thermal prefixing achieves the effect that the powder material 1002 adheres better to the web of material 1000 and the web of material 1000 becomes flexurally more rigid. This produces improved transporting properties of the web of material 1000. The web of material 1000, which is thus provided with powder images 100 (see FIG. 4) is subsequently divided into individual sheets 1004 by using a cross-cutter 6. The cross-cutter 6 may be constructed, for example, as a rotary cutting system with cutter rollers. In order to ensure that the cross-cut is introduced into the web of material 1000 at the correct position, a register detection system 5, which has a camera, is provided. The individual sheets 1004 are transported further by a sheet transporting device 3, for example constructed as a transporting belt, to a stacking system 7 and are stacked there on a stack of sheets 1005. The stacking system 7 has non-illustrated stops, which make it possible for the sheets 1004 to be stacked in precise register. A temperature-assisted pressing device 8, which serves for the pressing and baking of the stack of sheets 1005, may be integrated in the stacking system 7. Alternatively, the stack of sheets 1005 may be transported further to such a pressing device 8 applying a pressing force F. In the method step of pressing and baking, the powder material is cured and the 3D object 1006 to be generated is produced. In order to expose the 3D object 1006 and free it of the sheet material lying around it and surrounding the object, the pressed and baked stack of sheets 1005 is passed on to a sandblasting device 9. Alternatively, a chemical washing-out or other selective material-removing treatment method may also be used.

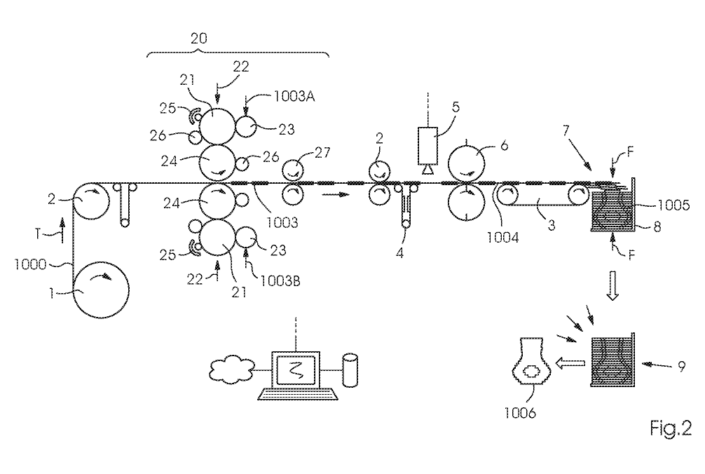

An alternative variant of an embodiment of a system for creating 3D objects 1006 is represented in FIG. 2. Instead of the inkjet imaging system 10 according to FIG. 1, in this case a toner imaging system 20 is used. The toner imaging system 20 has at least one toner printing unit, which is disposed on one side of the web of printing material 1000. Alternatively, however, two printing units may also be provided, with a toner printing unit being disposed on each of the two sides of the web of material 1000. A respective toner printing unit includes a photoconductor drum 21, which is assigned a digital imaging unit 22. Partially powdered toner 1003, for example resin powder, is transferred onto the photoconductor drum 21 by a developer station 23. Due to the use of the digital imaging unit 22 and an electrical application or charging unit 25, the transfer takes place in this case in a manner analogous to the transfer of toner in the case of dry toner printing. Excess powder is removed by a cleaning system 26, with the powder itself being transferred onto the web of material 1000 by an intermediate carrier 24 with a printing blanket. A thermal prefixing of the powder material on the web of material 1000 is performed by using a downstream pair of fusing rollers 27.

In the variant embodiment represented in FIG. 2, having two printing units that may also be referred to as a simultaneous printing unit, the web of material 1000 is printed on both sides. It appears to be particularly advantageous if a two-component material 1003 including components 1003A and 1003B, for example a two-component resin, is used for the printing by the printing units.

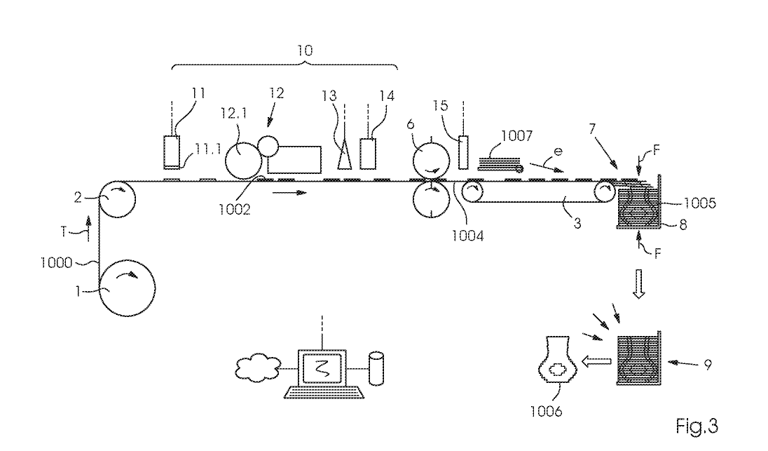

A variant of the system of FIG. 1 is represented in FIG. 3. A further inkjet print head 15 for printing colored or functional structures may be provided upstream of the stacking system 7 and sheets 1007 with additional functionality may be fed into the material stream of the sheets 1004 by a feeding-in operation e that is not represented any more specifically. It is thereby possible to produce a stack of sheets 1005, which includes both powdered and prefixed sheets 1004 and sheets 1007 with additional functionality. The sheets 1007 with additional functionality may be sheets that have a mechanical, electrical, thermal, magnetic or graphic function. In this case, a number of feeding-in devices may be provided, so that sheets 1007 with various functionality from various stacks of sheets can be pushed between the powdered sheets 1004 in each case by the feeding-in operation e.

FIG. 4 shows how an image 100 has been printed onto the web of material 1000 and powdered. A respective printed image 100 in this case represents a cross section in a specific sectional plane through the 3D object 1006 to be generated. It is particularly advantageous if, as represented in FIG. 4, a number of objects 1006 are generated simultaneously, in order to better utilize the surface area of the web of material 1000. In the example represented in FIG. 4, six objects are generated simultaneously. The rectangular cross section 101 of a first object, four circular cross sections 102 of a second object as well as an oval cross section 103 of a third object can be seen, with this third object having a further round body inside it. If only one object is to be generated, the cross section 103 may be supplemented by further cross sections 101, 102 of supporting objects, which form supporting structures.

1. A method for generating 3D objects, the method comprising the following steps:
a) providing a web of material;
b) printing an image by inkjet printing, the image corresponding to a section in a plane of the 3D object to be generated;
c) applying a powder to a portion of the web of material provided with the image;
d) cross-cutting the printed web of material into sheets;
e) stacking the sheets in precise register on a stack of sheets;
f) repeating steps b) to e);
g) pressing the stack of sheets; and
h) exposing the object.

2. The method for generating 3D objects according to claim 1, which further comprises strengthening the web of material in a region of side edges of the web of material, before step b).

3. The method for generating 3D objects according to claim 1, which further comprises printing sections of a number of objects in nested positioning in step b).

4. The method for generating 3D objects according to claim 1, which further comprises using an inkjet printing unit with at least one inkjet printhead in step b).

5. The method for generating 3D objects according to claim 1, which further comprises using a powder unit in step c).

6. The method for generating 3D objects according to claim 5, which further comprises providing the powder unit with an electrostatic powder roller.

7. The method for generating 3D objects according to claim 4, which further comprises:
placing the inkjet printing unit and the powder unit on the same side of the web of material; and
guiding the web of material horizontally in a vicinity of the inkjet printing unit and the powder unit.

8. The method for generating 3D objects according to claim 5, which further comprises:
placing the inkjet printing unit and the powder unit on the same side of the web of material; and
guiding the web of material horizontally in a vicinity of the inkjet printing unit and the powder unit.

9. The method for generating 3D objects according to claim 1, which further comprises printing an image by inkjet printing from both sides of the web of material and simultaneously guiding the web of material vertically, in step b).

10. The method for generating 3D objects according to claim 1, which further comprises at least one of:
c2) removing excess powder, or
c3) prefixing the powder.

11. The method for generating 3D objects according to claim 1, which further comprises feeding-in sheets with various functionality in step e).

12. A method for generating 3D objects, the method comprising the following steps:
a) providing a web of material;
b) printing an image on one or both sides of the web of material by electrophotographic printing,
the image corresponds to a section in a plane of the 3D object to be generated, and
using two-component materials for the printing when printing on both sides;
c) cross-cutting the printed web of material into sheets;
d) stacking the sheets in precise register on a stack of sheets;
e) repeating steps b) to d);
f) pressing the stack of sheets; and
g) exposing the object.
